(19) United States
(12) Patent Application Publication
(10) Pub. No.: US 2014/0117286 A1
(43) Pub. Date: May 1, 2014

(54) COMPOSITION FOR PREPARING SEMICONDUCTOR NANOCRYSTAL PARTICLE, AND METHOD OF PREPARING SEMICONDUCTOR NANOCRYSTAL USING SAME

(71) Applicant: SAMSUNG ELECTRONICS CO., LTD., Suwon-si (KR)

(72) Inventors: Shin Ae JUN, Seongnam-si (KR); Eun Joo JANG, Suwon-si (KR); Hyo Sook JANG, Suwon-si (KR); Seoung-Jae IM, Seoul (KR)

(73) Assignee: SAMSUNG ELECTRONICS CO., LTD., Suwon-si (KR)

(21) Appl. No.: 14/065,520

(22) Filed: Oct. 29, 2013

(30) Foreign Application Priority Data
Oct. 29, 2012 (KR) 10-2012-0120173

(51) Int. Cl. C09K 11/02

(52) U.S. Cl. CPC C09K 11/025
USPC 252/301.6 S; 423/299

(57) ABSTRACT

A composition for preparing a semiconductor nanocrystal, the composition including (i) a Group II and/or Group III precursor, (ii) a Group VI and/or Group V precursor, (iii) an acid anhydride or acyl halide, and (iv) a solvent.

### CROSS-REFERENCE TO RELATED APPLICATION

This application claims priority to and the benefit of Korean Patent Application No. 10-2012-0120173 filed on Oct. 29, 2012 and all the benefits accruing therefrom under 35 U.S.C. §119, the content of which is incorporated herein in its entirety by reference.

### BACKGROUND

1. Field

A composition for preparing a semiconductor nanocrystal and a method of preparing a semiconductor nanocrystal are disclosed.

2. Description of the Related Art

Semiconductor nanocrystals, which are also called quantum dots, are semiconductor materials with nano-sized particles having a crystalline structure, and including hundreds to thousands of atoms. Since the semiconductor nanocrystals are very small, they have a large surface area per unit volume, and display a quantum confinement effect. Accordingly, they have unique physicochemical properties that differ from the inherent characteristics of a corresponding bulk semiconductor material. Particularly, the photoelectron characteristics of nanocrystals may be controlled by adjusting their size, so they may be applied to a display element or a bio-light emitting display device or the like. A number of compositions for preparing semiconductor nanocrystals are known. However, there remains a need for a composition for preparing stable semiconductor nanocrystals in a short period of time.

### SUMMARY

An embodiment provides a composition for preparing a semiconductor nanocrystal so that a semiconductor nanocrystal may be provided within a short time and in a more stable way.

Another embodiment provides a method of preparing a semiconductor nanocrystal using the composition.

According to an embodiment, a composition for preparing a semiconductor nanocrystal, the composition including (i) a Group II and/or Group III precursor, (ii) a Group VI and/or Group V precursor, (iii) an acid anhydride or acyl halide, and (iv) a solvent is provided.

The acid anhydride may include at least one fatty acid anhydride selected from oleic anhydride, linolenic anhydride, stearic anhydride, lauric anhydride, and palmitic anhydride, at least one anhydride of phosphonic acid selected from hexyl phosphonic acid, n-octyl phosphonic acid, tetradecyl phosphonic acid, or octadecyl phosphonic acid, or at least one cyclic anhydride selected from succinic anhydride, or (2-dodecen-1-yl)succinic anhydride, but is not limited thereto.

An amount of the acid anhydride in the composition may be about 20 mol % to about 90 mol % based on the total of 100 mol % of (i) the Group II and/or Group III precursor, (ii) the Group VI and/or Group V precursor, and (iii) the acid anhydride.

The acyl halide may be an acetyl halide, benzoyl halide, an acyl halide having a C1 to C20 alkyl group, and the like.

A halogen element of the acyl halide may be acetyl fluoride, acetyl chloride, acetyl bromide, acetyl iodide, benzoyl fluoride, benzoyl chloride, benzoyl bromide, benzoyl iodide, or acyl fluoride including a C1 to C20 alkyl group, acyl chloride including a C1 to C20 alkyl group, acyl bromide including a C1 to C20 alkyl group, or acyl iodide including a C1 to C20 alkyl group.

An amount of the acyl halide in the composition may be about 20 mol % to about 90 mol % based on the total of 100 mol % of (i) the Group II and/or Group III precursor, (ii) the Group VI and/or Group V precursor, and (iii) the acyl halide.

The nanocrystal may be a core semiconductor nanocrystal.

The nanocrystal may be a semiconductor nanocrystal including a passivation shell layer formed from the Group II and the Group VI precursor and/or a passivation shell layer formed from the Group III precursor and the Group V precursor on a surface of the semiconductor nanocrystal.

In the composition, (i) the Group II and/or Group III precursor, (ii) the Group VI and/or Group V precursor, and (iii) the acid anhydride or acyl halide may each be present as an individual compound.

In the composition, (i) the Group II and/or Group III precursor and (ii) the Group VI and/or Group V precursor may be present in a form of a complex.

In the composition, (i) the Group II and/or Group III precursor, (ii) the Group VI and/or Group V precursor, and (iii) the acid anhydride or acyl halide may be present in a form of a complex.

The Group II and/or Group III precursor may be present in a form of an alkyl metal precursor, a metal salt, or a metal oxide.

The Group VI or Group V precursor may be a C1 to C36 alkyl thiol; S, Se, or Te dissolved in a C1 to C36 alkyl phosphine; S, Se, or Te; trimethylsilyl selenium, trimethylsilyl sulfur, or trimethylsilyl phosphine; tris-dimethylamido gallium; a C1 to C36 alkyl phosphine; or a C1 to C36 alkyl phosphite, but is not limited thereto.

According to another embodiment, a method of preparing a semiconductor nanocrystal that includes adding (i) a Group II and/or Group III precursor, (ii) a Group VI and/or Group V precursor, and (iii) an acid anhydride or acyl halide to a solvent to form a mixture.

The method may further include reacting the mixture of (i) the Group II and/or Group III precursor, (ii) the Group VI and/or Group V precursor, (iii) the acid anhydride or acyl halide, and the solvent upon heating.

The method may include adding a previously prepared semiconductor nanocrystal to the mixture of (i) the Group II and/or Group III precursor, (ii) the Group VI and/or Group V precursor, and (iii) the acid anhydride or acyl halide, and the solvent.

The semiconductor nanocrystal may include a passivation layer formed from the Group II precursor and/or the Group III precursor, and the Group VI and/or Group V precursor on a surface of the previously prepared semiconductor nanocrystal.

The method may provide a semiconductor nanocrystal having a core-shell structure by adding a second Group II and/or Group III precursor, and a second Group VI and/or Group V precursor to the solvent.

The Group III precursor may be a Ga precursor, and the Group V precursor may be a P precursor.

The Group III precursor may be a Ga precursor, and the Group V precursor may be a P precursor.

### BRIEF DESCRIPTION OF THE DRAWINGS

These and/or other aspects will become apparent and more readily appreciated from the following description of the embodiments, taken in conjunction with the accompanying drawings in which:

FIG. 1 is a ³¹P NMR graph of intensity (arbitrary unit, a. u.) versus frequency (part per million, ppm) showing whether a binding relationship between precursors for a composite is maintained when various materials are added to the semiconductor nanocrystal precursor complex.

FIG. 2 is a view schematically showing whether the binding relationship of semiconductor nanocrystal precursors is maintained during the reaction depending upon the kind of surfactant used.

FIG. 3 is a graph of light absorbance (arbitrary unit, a. u.) versus wavelength (nanometer, nm) showing whether semiconductor nanocrystals obtained from Example 1 and Comparative Example 1 are produced depending upon time.

FIG. 4 is a Transmission Electron Microscopy (“TEM”) photograph of nanocrystals obtained from Example 1.

FIG. 5 is a graph of light absorbance (arbitrary unit, a. u.) versus wavelength (nanometer, nm) showing the nanocrystal formation of semiconductor nanocrystals obtained from Example 2.

FIG. 6 is a Transmission Electron Microscopy (“TEM”) photograph of nanocrystals obtained from Example 2.

FIG. 7 is a graph of light absorbance (arbitrary unit, a. u.) versus wavelength (nanometer, nm) showing the nanocrystal formation of semiconductor nanocrystals obtained from Example 10.

FIG. 8 is a graph of light absorbance (arbitrary unit, a. u.) versus wavelength (nanometer, nm) showing the nanocrystal formation of semiconductor nanocrystals obtained from Experimental Examples 1 to 5.

FIG. 9 is a graph of light absorbance (arbitrary unit, a. u.) versus wavelength (nanometer, nm) comparing photo-efficiency of semiconductor nanocrystals obtained from Experimental Examples 1 to 5.

### DETAILED DESCRIPTION

This disclosure will be described more fully hereinafter in the following detailed description, in which some but not all embodiments of this disclosure are described. This disclosure may be embodied in many different forms and is not be construed as limited to the embodiments set forth herein; rather, these embodiments are provided so that this disclosure will fully convey the scope of the invention to those skilled in the art. Thus, in some exemplary embodiments, well known technologies are not specifically explained to avoid ambiguous understanding of the present invention. Unless otherwise defined, all terms used in the specification (including technical and scientific terms) may be used with meanings commonly understood by a person having ordinary knowledge in the art. Further, unless explicitly defined to the contrary, the terms defined in a generally-used dictionary are not ideally or excessively interpreted. In addition, unless explicitly described to the contrary, the word “comprise” and variations such as “comprises” or “comprising” will be understood to imply the inclusion of stated elements but not the exclusion of any other elements.

Unless specifically described to the contrary, a singular form includes a plural form.

The exemplary embodiments of the present invention described in the specification are explained referring to ideal exemplary drawings of schematic diagrams. Therefore, the parts exemplified in the drawings have outline properties and they are not to limit the categories of the invention. The same reference numerals designate the same constituent elements throughout the specification.

As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. Unless specified otherwise, the term “or” means “and/or.”

As used herein, a “mixture” refers to a combination of components in any form, for example solution, alloy, or sold/liquid.

As used herein, when a definition is not otherwise provided, the term “substituted” refers to one substituted with a substituent selected from a C1 to C30 alkyl group, a C2 to C30 alkenyl group, a C2 to C30 alkynyl group, a C6 to

C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (—F, —Cl, —Br, or —I), a hydroxy group (—OH), a nitro group (—NO₂), a cyano group (—CN), an amino group (—NRR′, wherein R and R′ are independently hydrogen or a C1 to C6 alkyl group), an azido group (—N₃), an amidino group (—C(═NH)NH₂), a hydrazine group (—NHNH₂), a hydrazono group (═N(NH₂), an aldehyde group (—C(═O)H), a carbamoyl group (—C(═O)NH₂), a thiol group (—SH), an ester group (—C(═O)OR, wherein R is a C1 to C6 alkyl group or a C6 to C12 aryl group), a carboxyl group (—C(═O)OH) or a salt thereof (—C(═O)OM, wherein M is an organic or inorganic cation), a sulfonic acid group (—SO₃H) or a salt thereof (—SO₃M, wherein M is an organic or inorganic cation), a phosphoric acid group (—PO₃H₂) or a salt thereof (—PO₃MH or —PO₃M₂, wherein M is an organic or inorganic cation), and a combination thereof, instead of hydrogen of a compound.

As used herein, the term “alkyl” refers to a monovalent group derived from a straight or branched chain saturated aliphatic hydrocarbon, and having a specified number of carbon atoms. Alkyl groups include, for example, methyl, ethyl, propyl, isopropyl, and hexyl.

As used herein, the term “alkenyl” refers to a monovalent group derived from a straight or branched chain saturated aliphatic hydrocarbon, having at least one double bond, and having a specified number of carbon atoms. Alkenyl groups include, for example, ethenyl and propenyl.

As used herein, the term “alkynyl” refers to a monovalent group derived from a straight or branched chain saturated aliphatic hydrocarbon, having at least one triple bond, and having a specified number of carbon atoms. Alkynyl groups include, for example, ethynyl and propynyl.

As used herein, the term “aryl” group, which is used alone or in combination, indicates a monovalent group derived from an aromatic hydrocarbon containing at least one ring, and having the specified number of carbon atoms. As used herein, the term “aryl” is construed as including a group with an aromatic ring fused to at least one cycloalkyl ring. Non-limiting examples of the “aryl” group include phenyl, naphthyl, and tetrahydronaphthyl.

As used herein, the term “alkylaryl” indicates an alkyl group covalently linked to a substituted or unsubstituted aryl group that is linked to a compound and having the specified number of carbon atoms. Non-limiting examples of the alkylaryl group include tolyl, ethylphenyl, and propylphenyl.

As used herein, the term “heteroalkylaryl” indicates an alkylaryl group, including at least one heteroatom selected from nitrogen (N), oxygen (O), phosphorous (P), and sulfur (S), and having the specified number of carbon atoms. A non-limiting example of the heteroalkylaryl group includes methoxyethylphenyl.

As used herein, the term “alkoxy” indicates “alkyl-O-”, wherein the alkyl is the same as described above and having the specified number of carbon atoms. Non-limiting examples of the alkoxy group include methoxy, ethoxy, propoxy, 2-propoxy, butoxy, t-butoxy, pentyloxy, hexyloxy, cyclopropoxy, and cyclohexyloxy.

As used herein, the term “heteroalkyl” indicates an alkyl group, including at least one heteroatom selected from nitrogen (N), oxygen (O), phosphorous (P), and sulfur (S), and having the specified number of carbon atoms. A non-limiting example of a heteroalkyl group includes methylthiomethyl (CH₃SCH₂—).

As used herein, the term “cycloalkyl” indicates a saturated hydrocarbon ring group, having only carbon ring atoms and having the specified number of carbon atoms. A non-limiting example of a cycloalkyl group includes cyclohexyl.

As used herein, the term “cycloalkenyl” indicates a saturated hydrocarbon ring group, having only carbon ring atoms, including at least one double bond, and having the specified number of carbon atoms. A non-limiting example of a cycloalkenyl group includes cyclohex-1-en-3-yl.

As used herein, the term “cycloalkynyl” indicates a saturated hydrocarbon ring group, having only carbon ring atoms, including at least one double bond, and having the specified number of carbon atoms. A non-limiting example of a cycloalkynyl group includes cyclooct-1-yn-3-yl.

As used herein, the term “heterocycloalkyl” indicates a saturated hydrocarbon ring group, including at least one heteroatom selected from nitrogen (N), oxygen (O), phosphorous (P), and sulfur (S), wherein the rest of the cyclic atoms are carbon, and having the specified number of carbon atoms.

A non-limiting example of a heterocycloalkyl group includes tetrahydro-2H-pyran-2-yl (C₅H₉O—).

As used herein, when a definition is not otherwise provided, the term “hetero” may refer to one including 1 to 3 heteroatoms selected from N, O, S, Si, or P.

As used herein, the term “alkylene group” may be a linear or branched saturated aliphatic hydrocarbon group that optionally include at least one substituent and has two or more valences.

As used herein, the term “arylene group” may be a functional group that optionally includes at least one substituent, and having two or more valences formed by removal of at least two hydrogens in at least one aromatic ring.

As used herein, the term “aliphatic organic group” may refer to a C1 to C30 linear or branched alkyl group, the term “aromatic organic group” may refer to a C6 to C30 aryl group or a C2 to C30 heteroaryl group, and the term “alicyclic organic group” may refer to a C3 to C30 cycloalkyl group, a C3 to C30 cycloalkenyl group, or a C3 to C30 cycloalkynyl group.

As used herein, the term “carbon-carbon unsaturated bond-containing substituent” may refer to a C2 to C20 alkenyl group including at least one carbon-carbon double bond, a C2 to C20 alkynyl group including at least one carbon-carbon triple bond, a C4 to C20 cycloalkenyl group including at least one carbon-carbon double bond in a ring, or a C4 to C20 cycloalkynyl group including at least one carbon-carbon triple bond in a ring.

As used herein, the term “combination thereof” refers to a mixture, a stacked structure, a composite, an alloy, a blend, a reaction product, or the like.

According to an embodiment, provided is a composition for preparing a semiconductor nanocrystal the composition including (i) a Group II and/or Group III precursor, (ii) a Group VI and/or Group V precursor, (iii) acid anhydride or acyl halide, and (iv) a solvent.

The acid anhydride or acyl halide may be used as a surfactant in a reaction of forming a semiconductor nanocrystal from the Group II and/or Group III precursor and the Group VI and/or Group V precursor.

The acid anhydride may include at least one fatty acid anhydride selected from oleic anhydride, linolenic anhydride, stearic anhydride, lauric anhydride, and palmitic anhydride, at least one anhydride of phosphonic acid selected from hexyl phosphonic acid, n-octyl phosphonic acid, tetradecylphosphonic acid, or octadecylphosphonic acid, or at least one cyclic anhydride selected from succinic anhydride, or (2-dodecen-1-yl)succinic anhydride, but is not limited thereto.

The acid anhydride may be included in an amount of about 20 mol % to about 90 mol % based on the total 100 mol % of (i) the Group II and/or Group III precursor, (ii) the Group VI and/or Group V precursor, and (iii) the acid anhydride in the solvent.

The acyl halide may be an acetyl halide, an acyl halide having a C1 to C20 alkyl group, or an aroyl halide such as a benzoyl halide, and the like.

A halogen element of the acyl halide may be fluoride, chloride, bromide, or iodide, and thus the acyl halide may be acyl fluoride, acyl chloride, acyl bromide, or acyl iodide.

In an embodiment, the acyl halide may be acetyl fluoride, acetyl chloride, acetyl bromide, acetyl iodide, benzoyl fluoride, benzoyl chloride, benzoyl bromide, benzoyl iodide, or acyl fluoride having a C1 to C20 alkyl group, acyl chloride having a C1 to C20 alkyl group, acyl bromide having a C1 to C20 alkyl group, or acyl iodide having a C1 to C20 alkyl group. For example, the acyl halide having a C1 to C20 alkyl group may be octadecanoyl chloride, hexadecanoyl bromide, and the like.

The acyl halide may be included in an amount of about 20 mol % to about 90 mol % based on the total of 100 mol % of (i) the Group II and/or Group III precursor, (ii) the Group VI and/or Group V precursor, and (iii) the acyl halide.

The semiconductor nanocrystal may be prepared in various methods, but nano-sized, for example, nanometer-sized semiconductor nanocrystals may be generally prepared in accordance with a wet chemical process.

The wet chemical process is a method of growing a semiconductor nanocrystal particle by adding a semiconductor precursor material into an organic solvent, wherein the organic solvent or organic ligand is naturally coordinated to the surface of the semiconductor nanocrystal during the crystal growth to control the crystal growth.

In order to prepare a semiconductor nanocrystal using the wet chemical process, a surfactant and the nanocrystal precursor may be added to assist the nanocrystal forming reaction. The surfactant protects the surface of the nanocrystal and also maintains the light emitting and electrical characteristics of the nanocrystal. The surfactant is a compound having a functional group which binds to a nanocrystal precursor or which binds to the surface of the nanocrystal at one end thereof, and generally includes a material such as a carboxylic acid, a phosphonic acid, a C6 to C22 alkyl amine, TOPO (trioctylphosphine oxide), a C1 to C36 alkyl phosphine, or the like. However, depending upon the kind of the nanocrystal precursor, the surfactant may be strongly bonded to one precursor of the nanocrystal to prevent the binding reaction of the precursors; or the surfactant may be strongly bonded to the produced nanocrystal surface to prevent the crystal growth.

However, as in an embodiment, when an anhydrous fatty acid such as oleic anhydride is used as a surfactant in components of composition for synthesizing the nanocrystal, the synthesis reaction rate of the nanocrystal may be greater and the reaction may be more stably and more uniformly performed than in the case when a non-anhydrous fatty acid such as oleic acid or oleic acid amine is used alone.

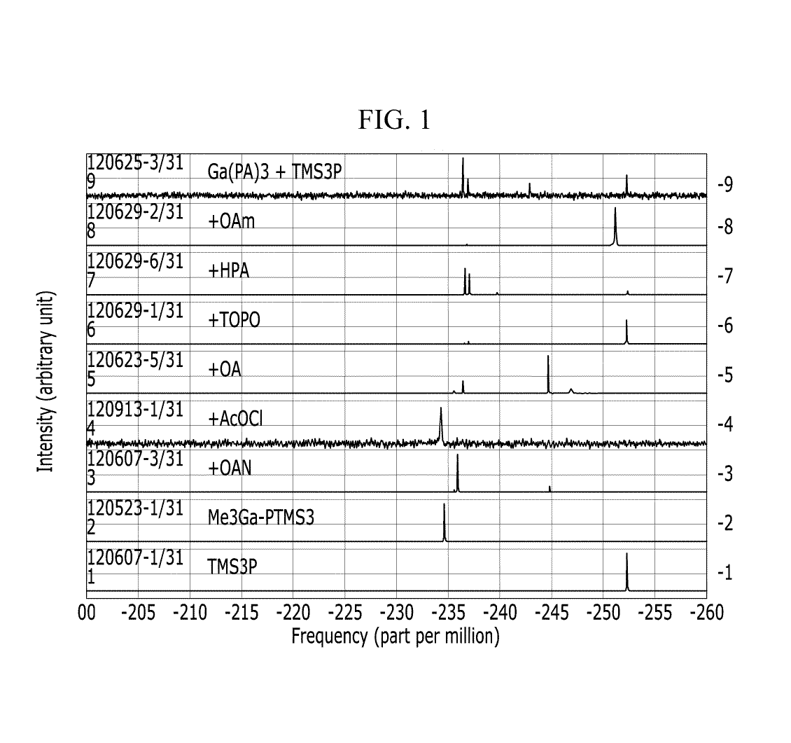

Without being bound to a specific theory, as shown in FIG. 1, it is believed that the binding relationship between nanocrystal precursors is continuously maintained during the synthesis process of the semiconductor nanocrystal when the acid anhydride or acyl halide is used as a surfactant. On the other hand, when the conventional acid or amine, TOPO (trioctylphosphine oxide) component, or the like is used as a surfactant, the binding relationship between precursors is not continuously maintained.

FIG. 1 is a ³¹P NMR graph indirectly confirming the binding relationship of semiconductor nanocrystal precursor materials upon addition of various materials as surfactants.

FIG. 1 shows ³¹P NMR peaks of the control groups when each of the semiconductor nanocrystal precursor materials of Ga(Me)₃ and TMS₃P (tri(trimethylsilyl)phosphine) is measured as an individual compound and when the TMS₃P (tri(trimethylsilyl)phosphine) is individually measured, the cases of forming a complex (Me₃Ga-PTMS₃) from the precursor materials, and the case of adding each of the various kinds of surfactants into the complex.

As shown in the graph, it is observed that one peak is found at a position transported from the original precursors when forming a composite from two precursor materials; but it is also observed that several peaks of greater than or equal to about two peaks are found when two precursor materials may not form one complex but may be decomposed and returned to the original form of the precursor or changed into other forms.

For example, in FIG. 1, in the case of adding each of OAm (oleic acid amine), HPA (hexadecylamine), TOPO (trioctylphosphine oxide), oleic acid (“OA”), and oleic anhydride (“OAN”), when adding oleic anhydride (“OAN”) or acetyl chloride (“AcOCl”), although it is slightly different from the peak and the position showing the complex, one sharp peak and one very small peak are found at almost the identical position. On the other hand, when adding non-anhydrous oleic acid (“OA”) itself, TOPO (trioctylphosphine oxide), oleic acid amine (“OAm”), or the like, the peak nearly disappears at the position indicating the complex, and the peak is found at a similar position to the peak position indicating the TMS₃P single precursor. In addition, when adding HPA, two small peaks and two very small different peaks are found at the similar position to the position indicating the case when the Ga(PA)₃ and TMS₃P precursor materials are mixed as each individual compound.

In this way, differing from the conventionally used surfactant such as an acid, amine, TOPO (trioctylphosphine oxide), or the like, when an acid anhydride or an acyl halide such as acetyl chloride is used as a surfactant, it is understood that the forming and growing of the nanocrystal are performed in a shorter time and a more stable way while maintaining the bond between precursors forming the semiconductor nanocrystal.

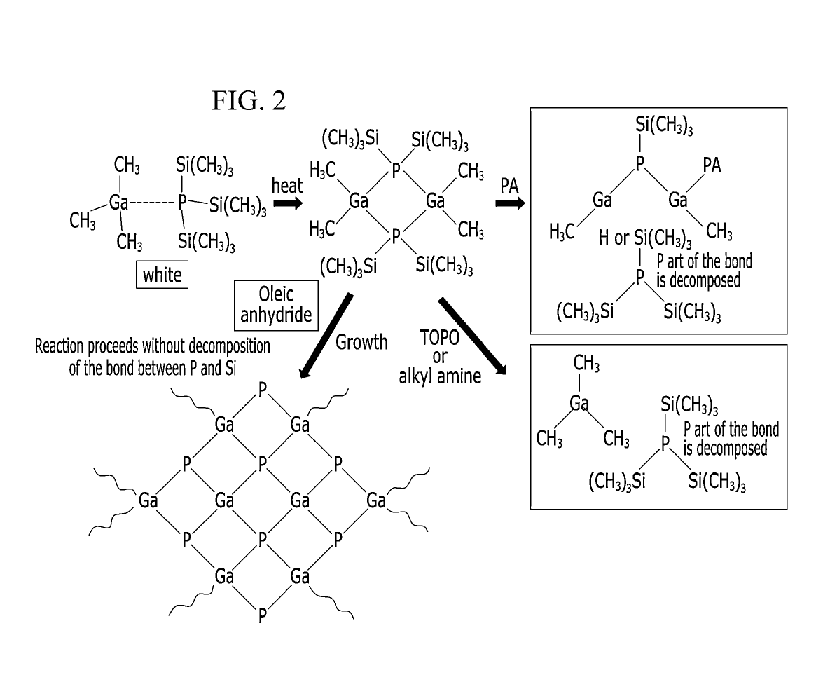

FIG. 2 is a schematic view showing the shapes of forming, maintaining, or breaking the binding relationship of the semiconductor nanocrystal precursors. The semiconductor nanocrystal precursors are bonded to provide a composite and to grow a nanocrystal.

In this case, while growing the nanocrystal precursors to the nanocrystal, when adding a carboxylic acid of palmitic acid (“PA”), the bond of the nanocrystal precursor complex is broken to return the original nanocrystal precursor, or a part thereof is changed to the decomposed form, so the reactivity of the nanocrystal precursor is changed to perform a non-uniform reaction, and the growth of the nanocrystal is also difficult. In addition, even when adding TOPO (trioctylphosphine oxide), a C6 to C22 alkyl amine, or the like, the binding relationship may not be maintained, and it may be decomposed to a different form from the original form.

However, when adding the acid anhydride such as oleic anhydride or the acyl halide such as acetyl chloride, the bonds in the nanocrystal precursor complex are effectively maintained, so the semiconductor nanocrystal may be grown within a shorter time and in a more stable way.

The nanocrystal may be a core semiconductor nanocrystal.

The nanocrystal may be a semiconductor nanocrystal including a passivation shell layer formed from the Group II and the Group VI precursor and/or a passivation shell layer formed from the Group III precursor and the Group V precursor on a surface of the semiconductor nanocrystal core.

The semiconductor nanocrystal including the semiconductor passivation layer may be prepared by adding a previously prepared core material of the semiconductor nanocrystal to the composition for preparing the semiconductor nanocrystal according to the above embodiment and reacting them, to form a passivation layer formed from the Group II and/or Group III precursor, and the Group VI and/or Group V precursor, on a core surface of the previously prepared semiconductor nanocrystal.

On the core of the semiconductor nanocrystal, or on the semiconductor nanocrystal including the semiconductor passivation layer, an additional semiconductor passivation layer may be further provided. In this case, the additionally formed semiconductor passivation layer may be applied by the conventional passivation method. The semiconductor passivation layer formed on the surface of the core of the semiconductor nanocrystal may play a role of growing the passivation layer well in thickness and simultaneously providing a wider bandgap than the core by lowering the lattice mismatch between the additionally formed semiconductor passivation layer and the core of the semiconductor nanocrystal to enhance the luminous efficiency.

In the composition, (i) the Group II and/or Group III precursor, (ii) the Group VI and/or Group V precursor, and (iii) the acid anhydride or acyl halide may each be present as an individual compound.

In the composition, (i) the Group II and/or Group III precursor and (ii) the Group VI and/or Group V precursor may each be present in a form of a complex.

The Group II precursor and the Group VI precursor may be a precursor in a form of a complex, or the Group III precursor and the Group V precursor may be a precursor in a form of a complex.

In the composition, (i) the Group II and/or Group III precursor, (ii) the Group VI and/or Group V precursor, and (iii) the acid anhydride or acyl halide may be present in a form of a complex.

That is to say, the Group II precursor, the Group VI precursor, and the acid anhydride or acyl halide may be present in a form of one complex, and/or the Group III precursor, the Group V precursor, and the acid anhydride or acyl halide may be present in a form of another complex.

The Group II or Group III precursor may be an alkyl metal precursor, a metal salt precursor, or a metal oxide precursor.

The Group II or Group III precursor used as a precursor of the semiconductor nanocrystal may be dimethyl zinc, diethyl zinc, zinc acetate, zinc acetylacetonate, zinc iodide, zinc bromide, zinc chloride, zinc fluoride, zinc carbonate, zinc cyanide, zinc nitrate, zinc oxide, zinc peroxide, zinc perchlorate, zinc sulfate, dimethyl cadmium, diethyl cadmium, cadmium acetate, cadmium acetylacetonate, cadmium iodide, cadmium bromide, cadmium chloride, cadmium fluoride, cadmium carbonate, cadmium nitrate, cadmium oxide, cadmium perchlorate, cadmium phosphide, cadmium sulfate, mercury acetate, mercury iodide, mercury bromide, mercury chloride, mercury fluoride, mercury cyanide, mercury nitrate, mercury oxide, mercury perchlorate, mercury sulfate, lead acetate, lead bromide, lead chloride, lead fluoride, lead oxide, lead perchlorate, lead nitrate, lead sulfate, lead carbonate, tin acetate, tin bisacetylacetonate, tin bromide, tin chloride, tin fluoride, tin oxide, tin sulfate, germanium tetrachloride, germanium oxide, germanium ethoxide, tris-dimethylamido gallium, trimethyl gallium, triethyl gallium, gallium acetylacetonate, gallium chloride, gallium fluoride, gallium oxide, gallium nitrate, gallium sulfate, trimethyl indium, triethyl indium, indium chloride, indium oxide, indium nitrate, indium sulfate, indium acetate, and the like, but is not limited thereto.

The metal oxide precursor may be selected from a metal alkoxide, a metal halide, and a metal hydroxide, but is not limited thereto.

The metal alkoxide may be selected from titanium methoxide, titanium ethoxide, titanium isopropoxide, titanium butoxide, zinc methoxide, zinc ethoxide, zinc isopropoxide, zinc butoxide, tetramethylorthosilicate, tetraethylorthosilicate, silicon tetraisopropoxide, silicon tetrabutoxide, trimethoxy silane, triethoxy silane, mercapto propyl trimethoxy silane, mercapto propyl triethoxy silane, amino propyl trimethoxy silane, amino propyl triethoxy silane, tin methoxide, tin ethoxide, tin isopropoxide, tin butoxide, tungsten methoxide, tungsten ethoxide, tungsten isopropoxide, tungsten butoxide, tantalum methoxide, tantalum ethoxide, tantalum isopropoxide, tantalum butoxide, barium methoxide, barium ethoxide, barium isopropoxide, barium butoxide, zirconium methoxide, zirconium ethoxide, zirconium isopropoxide, zirconium butoxide, aluminum methoxide, aluminum ethoxide, aluminum isopropoxide, aluminum butoxide, yttrium methoxide, yttrium ethoxide, yttrium isopropoxide, yttrium butoxide, iron methoxide, iron ethoxide, iron isopropoxide, iron butoxide, cesium methoxide, cesium ethoxide, cesium isopropoxide, cesium butoxide, chromium methoxide, chromium ethoxide, chromium isopropoxide, chromium butoxide, and a mixture thereof. The metal halide may be selected from titanium chloride, zinc chloride, silicon tetrachloride, tin chloride, tungsten chloride, tantalum chloride, barium chloride, zirconium chloride, hafnium chloride, aluminum chloride, yttrium chloride, iron(II) chloride, iron(III) chloride, cesium chloride, chromium chloride, titanium bromide, zinc bromide, silicon tetrabromide, tin bromide, tungsten bromide, tantalum bromide, barium bromide, zirconium bromide, hafnium bromide, aluminum bromide, yttrium bromide, iron(II) bromide, iron(III) bromide, cesium bromide, chromium bromide, titanium iodide, zinc iodide, silicon tetraiodide, tin iodide, tungsten iodide, tantalum iodide, barium iodide, zirconium iodide, hafnium iodide, aluminum iodide, yttrium iodide, iron(II) iodide, iron(III) iodide, cesium iodide, chromium iodide, and a mixture thereof.

The metal hydroxide may be selected from titanium hydroxide, zinc hydroxide, silicon hydroxide, tin hydroxide, tungsten hydroxide, tantalum hydroxide, barium hydroxide, zirconium hydroxide, hafnium hydroxide, aluminum hydroxide, yttrium hydroxide, iron(II) hydroxide, iron(III) hydroxide, cesium hydroxide, chromium hydroxide, or a mixture thereof.

The Group VI or Group V precursor as the precursor of the semiconductor nanocrystal may be a C1 to C36 alkyl thiol; S, Se, or Te dissolved in a C1 to C36 alkyl phosphine; S, Se, or Te; trimethylsilyl selenium, trimethylsilyl sulfur, or trimethylsilyl phosphine; a C1 to C36 alkyl phosphine; a C1 to C36 alkyl phosphite; or tris-dimethylamido gallium.

In an embodiment, the Group VI or Group V compound as the precursor of the semiconductor nanocrystal may be a C1 to C36 alkyl thiol compound such as hexane thiol, octane thiol, decane thiol, dodecane thiol, hexadecane thiol, mercapto propyl silane, sulfur-trioctyl phosphine (“S-TOP”), sulfur-tributyl phosphine (“S-TBP”), sulfur-triphenyl phosphine (“S-TPP”), sulfur-trioctylamine (“S-TOA”), trimethylsilyl sulfur, ammonium sulfide, sodium sulfide, selenium-trioctylphosphine (“Se-TOP”), selenium-tributylphosphine (“Se-TBP”), selenium-triphenylphosphine (“Se-TPP”), tellurium-tributylphosphine (“Te-TBP”), tellurium-triphenylphosphine (“Te-TPP”), trimethylsilyl phosphine, and a C1 to C36 alkyl phosphine such as triethylphosphine, tributylphosphine, trioctylphosphine, triphenylphosphine, and tricyclohexylphosphine, arsenic oxide, arsenic chloride, arsenic sulfate, arsenic bromide, arsenic iodide, nitrous oxide, nitric acid, ammonium nitrate, tri-isopropyl phosphite, and the like.

The solvent in the composition for preparing a semiconductor nanocrystal may be a C6 to C22 primary alkyl amine, a C6 to C22 secondary alkyl amine, and a C6 to C22 tertiary alkyl amine; a C6 to C22 primary alcohol, a C6 to C22 secondary alcohol, and a C6 to C22 tertiary alcohol; a C6 to C22 ketone, a C6 to C22 ester; a C6 to C22 heterocyclic compound including nitrogen or sulfur; a C6 to C22 alkane, a C6 to C22 alkene, a C6 to C22 alkyne; trioctylamine, trioctylphosphine, trioctylphosphine oxide, octyl ether, benzyl ether, and the like, or a combination thereof.

The semiconductor nanocrystal prepared according to the above embodiment may have various shapes depending on reaction conditions. For example, the semiconductor nanocrystal prepared according to the above embodiment may have various vertical and horizontal cross-sectional shapes, e.g., circular shape, triangular shape, quasi-triangular shape, triangular shape with semi-circles, triangular shape with one or more rounded corners, square shape, rectangular shape, rectangular shape with semi-circles, polygonal shape, or any of various common regular and irregular shapes. The semiconductor nanocrystal prepared according to the above embodiment may have various three-dimensional shapes selected from spherical shape, elliptical shape, tetrahedral shape, pyramidal shape, octahedral shape, cylindrical shape, rod-like shape, triangle-like shape, disc-like shape, tripod-like shape, tetrapod-like shape, cubical shape, box-like shape, star-like shape, and tubular shape, polygonal pillar-like shape, conical shape, columnar shape, helical shape, funnel shape, dendritic shape, or any of various common regular and irregular shapes without limitation.

The nanocrystal may efficiently emit visible light and light in other regions (for example, ultraviolet (“UV”) light or infrared (“IR”) light).

According to another embodiment, a method of preparing a semiconductor nanocrystal that includes adding (i) a Group II and/or Group III precursor, (ii) a Group VI and/or Group V precursor, and (iii) an acid anhydride or acyl halide in a solvent to form a mixture is provided.

The method may further include reacting the mixture of (i) the Group II and/or Group III precursor, (ii) the Group VI and/or Group V precursor and (iii) the acid anhydride or acyl halide in the solvent upon heating.

After adding the precursors of the semiconductor nanocrystal and the acid anhydride or acyl halide into the solvent, the reaction mixture may be heated until reaching the reaction temperature. Alternatively, the reaction may be performed by injecting the precursor of the semiconductor nanocrystal and the acid anhydride or acyl halide into the reaction solvent which is pre-heated to the reaction temperature.

The method may further include quenching the reaction by cooling the reactant at the time of completion of the reaction.

According to another embodiment, the method may include adding the previously prepared semiconductor nanocrystal into the mixture of (i) a Group II and/or Group III precursor, (ii) a Group VI and/or Group V precursor, (iii) an acid anhydride or acyl halide, and solvent.

By adding the precursors together with the previously prepared semiconductor nanocrystal, a semiconductor nanocrystal including a passivation layer formed from the Group II precursor and the Group VI precursor and/or the Group III precursor and the Group V precursor may be provided on the surface of the semiconductor nanocrystal.

Alternatively, during the process of providing the passivation layer, as well as inputting the previously prepared semiconductor nanocrystal core, the semiconductor nanocrystal including a semiconductor nanocrystal core and a passivation layer may be prepared by adding a Group II and/or Group III precursor, and a Group VI and/or Group V precursor for the semiconductor core and a precursor and acid anhydride or acyl halide to be first reacted; and then continuously adding a precursor for a passivation or the acid anhydride or acyl halide together with the precursor for a passivation thereto after providing a semiconductor nanocrystal core from the Group II and/or Group III precursor and the Group VI and/or Group V precursor.

The method may provide a semiconductor nanocrystal in an alloy of the precursor for the first semiconductor nanocrystal and the precursor for the second semiconductor nanocrystal by adding a second Group II and/or Group III precursor and a second Group VI and/or Group V precursor into a solvent for a semiconductor nanocrystal core or a solvent for forming a passivation layer on the semiconductor nanocrystal core. A semiconductor nanocrystal having a core-shell structure may be provided by the reactivity difference.

The semiconductor nanocrystal prepared according to the preparation method may be a Group II-VI compound, a Group III-V compound, or a mixture of the Group II-VI compound and the Group III-V compound.

The Group II-VI compound may be a material selected from a binary element compound selected from CdS, CdSe, CdTe, ZnS, ZnSe, ZnTe, ZnO, HgS, HgSe, HgTe, and the like, a ternary element compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, and the like, or a quaternary element compound selected from CdZnSeS, CdZnSeTe, CdZnSTe, CdHgSeS, CdHgSeTe, CdHgSTe, HgZnSeS, HgZnSeTe, HgZnSTe, and the like, and the Group III-V compound semiconductor may be a material selected from a binary element compound selected from GaN, GaP, GaAs, GaSb, AlN, AlP, AlAs, AlSb, InN, InP, InAs, InSb, and the like, a ternary element compound selected from GaNP, GaNAs, GaNSb, GaPAs, GaPSb, AlNP, AlNAs, AlNSb, AlPAs, AlPSb, InNP, InNAs, InNSb, InPAs, InPSb, GaAlNP, AlGaN, AlGaP, AlGaAs, AlGaSb, InGaN, InGaP, InGaAs, InGaSb, AlInN, AlInP, AllnAs, AllnSb, and the like, or a quaternary element compound selected from GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and the like, and may be a mixture of a Group II-VI and a Group III-V compound, without limitation.

In the manufacturing method, by adding the precursor together with the previously prepared semiconductor nanocrystal, when the semiconductor nanocrystal includes a passivation layer formed with the Group II precursor and the Group VI precursor and/or the Group III precursor and the Group V precursor on the surface of the semiconductor nanocrystal, the passivation layer may be formed with the Group II-VI compound or the Group III-V compound, or a mixture of two compounds.

In addition, when the nanocrystal has a structure of a core and a shell, both the core and the shell may be formed with the Group II-VI compound or the Group III-V compound, or a mixture of two compounds; or each of the core and the shell may be formed with different semiconductor nanocrystal compounds from each other.

In the preparation method, (i) the Group II and/or Group III precursor, (ii) the Group VI and/or Group V precursor, (iii) the acid anhydride or acyl halide, and (iv) the solvent are the same as described in the above embodiment, and thus their descriptions are not provided.

Hereinafter, the present invention is illustrated in more detail with reference to examples. However, they are exemplary embodiments, and the present invention is not limited thereto.

### EXAMPLES

### Example 1

### Preparation of Semiconductor Nanocrystal GaP

0.4 mmol of Ga(Me)₃, 0.4 mmol of (TMS)₃P, and 0.5 mL of hexane are mixed in a glove box and injected to 10 mL of trioctylamine (hereinafter referred to as “TOA”) heated to 330° C., and dripped with 1.2 mmol of an oleic anhydride (OAN)/TOA solution after 30 seconds and reacted for 22 hours. After the reaction, the solution is cooled to 40° C., and then the reactor is opened and added with ethanol to separate a precipitate which is then dispersed in toluene.

### Comparative Example 1

### Preparation of Semiconductor Nanocrystal GaP

0.4 mmol of Ga(Me)₃, 0.4 mmol of (TMS)₃P, and 0.5 mL of hexane are mixed in a glove box and injected to 10 mL of TOA heated to 330° C. and dripped with 1.2 mmol of a palmitic acid (PA)/TOA solution after 30 seconds, and a sample is taken every 23 hours and the reaction is continued for a total of 72 hours. After the reaction, the solution is cooled to 40° C., and then the reactor is opened and added with ethanol to separate a precipitate which is then dispersed in toluene.

### Example 2

### Preparation of Semiconductor Nanocrystal GaP

0.4 mmol of Ga(Me)₃, 0.4 mmol of triisopropyl phosphite, and 0.5 mL of hexane are mixed in a glove box and injected to 10 mL of TOA heated to 330° C., and dripped with 1.2 mmol of an oleic anhydride (OAN)/TOA solution after 30 seconds and reacted for 24 hours. After the reaction, the solution is cooled to 40° C., and then the reactor is opened and added with ethanol to separate a precipitate which is then dispersed in toluene.

### Example 3

### Preparation of Semiconductor Nanocrystal GaP

0.4 mmol of a Ga(Me)₂—P(TMS)₂ composite and 0.5 mL of toluene are mixed in a glove box and injected to 10 mL of TOA heated to 330° C., and dripped with 1.2 mmol of an oleic anhydride (OAN)/TOA solution after 30 seconds and reacted for 24 hours. After the reaction, the solution is cooled to 40° C., and then the reactor is opened and added with ethanol to separate a precipitate which is then dispersed in toluene.

### Example 4

### Preparation of Semiconductor Nanocrystal GaP

0.4 mmol of a GaCl₂—P(TMS)₂ composite and 0.5 mL of toluene are mixed in a glove box and injected to 10 mL of TOA heated to 330° C., and dripped with 1.2 mmol of an oleic anhydride (OAN)/TOA solution after 30 seconds and reacted for 24 hours. After the reaction, the solution is cooled to 40° C., and then the reactor is opened and added with ethanol to separate a precipitate which is then dispersed in toluene.

### Example 5

### Preparation of Semiconductor Nanocrystal GaP

0.4 mmol of a tris(di-tert-butylphosphino)gallium (Ga(PtBu₂)₃) composite and 0.5 mL of toluene are mixed in a glove box and injected to 1.2 mmol of TOPO/10 mL of TOA heated to 330° C., and dripped with 1.2 mmol of an oleic anhydride (OAN)/TOA solution after 30 seconds and reacted for 24 hours.

After the reaction, the solution is cooled to 40° C., and then the reactor is opened and added with ethanol to separate a precipitate which is then dispersed in toluene.

### Example 6

### Preparation of Semiconductor Nanocrystal GaP

0.4 mmol of Ga(Et)₃, 0.4 mmol of (TMS)₃P, and 0.5 mL of hexane are mixed in a glove box and injected to 10 mL of TOA heated to 330° C., and dripped with 1.2 mmol of an oleic anhydride (OAN)/TOA solution after 30 seconds and reacted for 24 hours. After the reaction, the solution is cooled to 40° C., and then the reactor is opened and added with ethanol to separate a precipitate which is then dispersed in toluene.

### Example 7

### Preparation of Semiconductor Nanocrystal GaP

0.4 mmol of Ga(Me)₃, 0.4 mmol of (TMS)₃P, and 0.5 mL of hexane are mixed in a glove box and injected to 1.2 ml of TOPO/10 mL of TOA heated to 330° C., and dripped with 1.2 mmol of an oleic anhydride (OAN)/TOA solution after 30 seconds and reacted for 24 hours. After the reaction, the solution is cooled to 40° C., and then the reactor is opened and added with ethanol to separate a precipitate which is then dispersed in toluene.

### Example 8

### Preparation of Semiconductor Nanocrystal GaP

0.4 mmol of Ga(Me)₃, 0.4 mmol of (TMS)₃P, and 0.5 mL of hexane are mixed in a glove box and injected to 0.4 ml of TOPO/10 mL of TOP heated to 330° C., and dripped with 1.2 mmol of an oleic anhydride (OAN)/TOA solution after 30 seconds and reacted for 24 hours. After the reaction, the solution is cooled to 40° C., and then the reactor is opened and added with ethanol to separate a precipitate which is then dispersed in toluene.

### Example 9

### Preparation of Semiconductor Nanocrystal GaP

0.4 mmol of Ga(Me)₃, 0.4 mmol of (TMS)₃P, and 0.5 mL of hexane are mixed in a glove box and injected to 0.4 ml of TOPO/0.2 mmol of TOP/10 mL of ODE heated to 260° C., and dripped with 1.2 mmol of an oleic anhydride (OAN)/TOA solution after 30 seconds and reacted for 72 hours. After the reaction, the solution is cooled to 40° C., and then the reactor is opened and added with ethanol to separate a precipitate which is then dispersed in toluene.

### Example 10

### Preparation of Semiconductor Nanocrystal InP

0.2 mmol of In(Me)₃, 0.1 mmol of (TMS)₃P, and 0.5 mL of hexane are mixed in a glove box and injected to 10 mL of TOA heated to 280° C. together with 1.2 mmol of an oleic anhydride (OAN)/TOA solution and reacted for 10 minutes. After the reaction, the solution is cooled to 40° C., and then the reactor is opened and added with ethanol to separate a precipitate which is then dispersed in toluene.

Evaluating Formation Rate and Stability of Semiconductor Nanocrystal

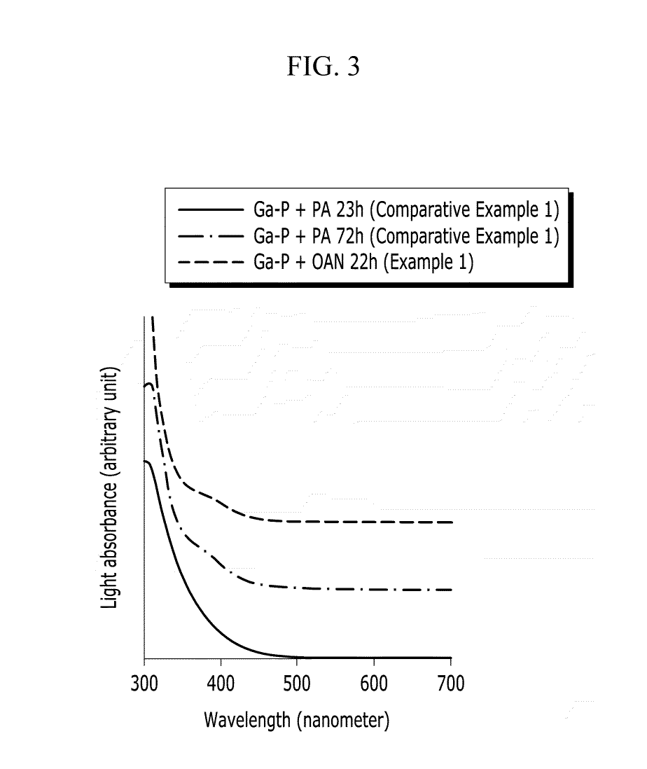

FIG. 3 shows a light absorption spectrum of a semiconductor nanocrystal obtained from Example 1 and a semiconductor nanocrystal obtained from Comparative Example 1 according to synthesis time.

As shown in FIG. 3, the case of Example 1 using the surfactant of oleic anhydride produces semiconductor nanocrystal after reaction for only 22 hours; on the other hand, in the case of the semiconductor nanocrystal according to Comparative Example 1, the nanocrystal production peak is not observed after reaction for 23 hours, but is observed after reaction for 72 hours.

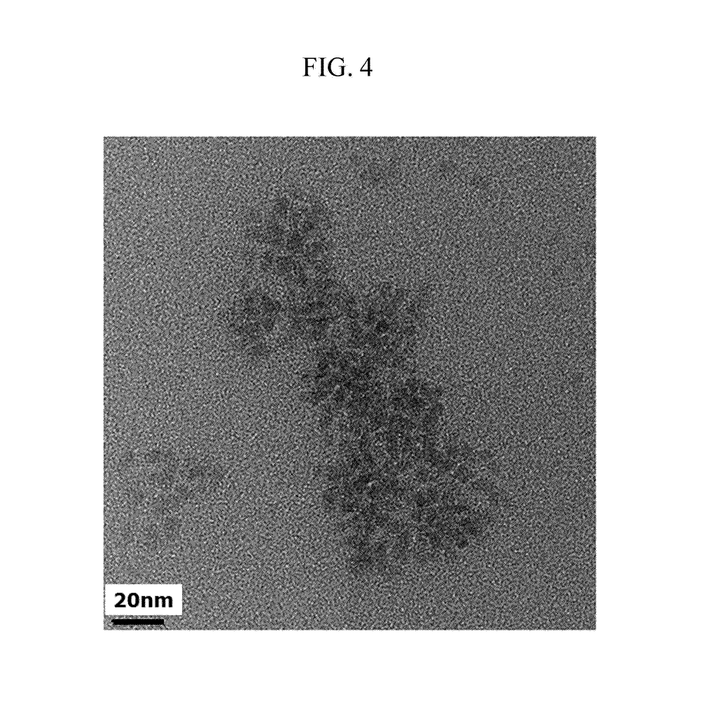

In addition, FIG. 4 is a TEM photograph of nanocrystal obtained from Example 1.

As shown in the photograph, a semiconductor nanocrystal having a comparatively larger particle size may be more quickly prepared in a more stable way by using acid anhydride as a surfactant.

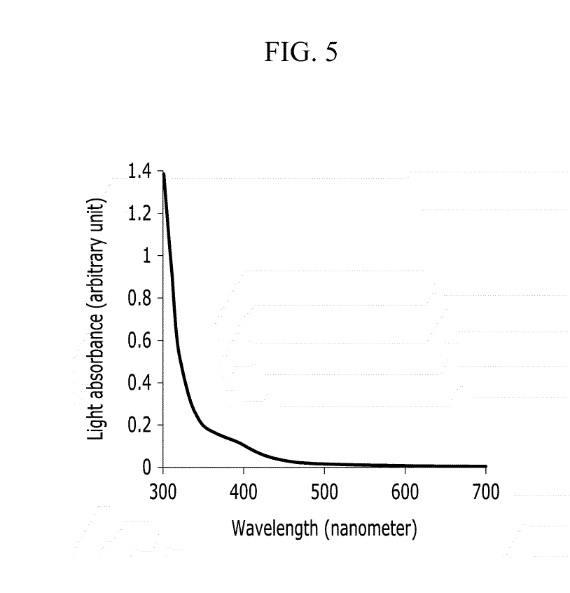

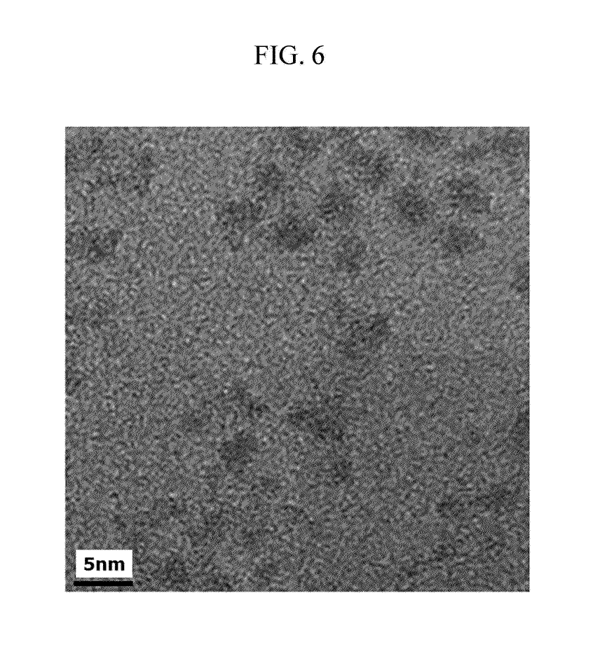

FIG. 5 is a graph showing formation of semiconductor nanocrystal obtained from Example 2; and FIG. 6 is a TEM photograph of semiconductor nanocrystal obtained from Example 2.

It is understood that a semiconductor nanocrystal having a stable size is prepared within a short time by using the acid anhydride in Example 2.

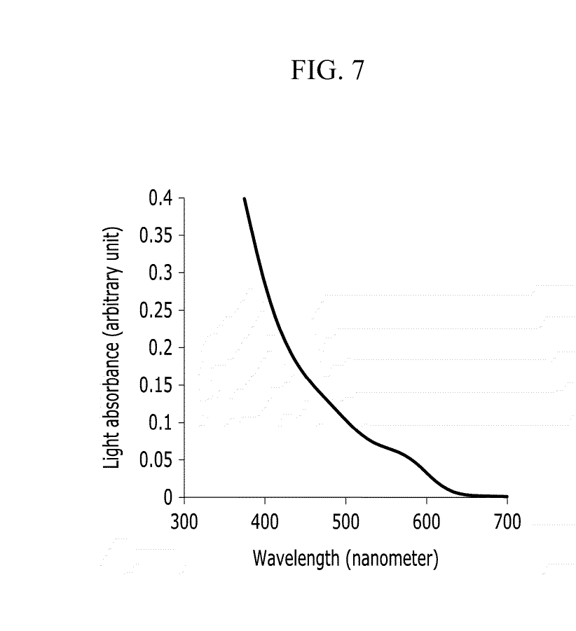

FIG. 7 is a graph showing formation of semiconductor nanocrystal obtained from Example 10. From the results of the examples and comparative examples, it is understood that a semiconductor nanocrystal may be stably prepared within a faster time and at a lower temperature by using acid anhydride as a surfactant compared to using an acid.

### Example 11

### Preparation of GaP and ZnS Shell Layer on InP/ZnS Core

0.02 mmol of Ga(Me)₃, 0.01 mmol of (TMS)₃P, and 0.5 mL of hexane are mixed in a glove box and injected to 10 mL of TOA heated to 260° C., and added with the previously prepared InP/ZnS nanocrystal core and dripped with 0.06 mmol of oleic anhydride and 0.3 mL of hexane and reacted for 15 hours. After the reaction, a solution of 0.3 mmol of Zn oleate/1 ml of TOA is dripped therein and diluted, and then additionally reacted at 150° C., and dripped again with a Zn oleate solution and dripped with 1.5 mL of 0.4 M S/TOP and heated to 300° C. and reacted for 1 hour. By the reaction, a semiconductor nanocrystal formed with a GaP and ZnS shell layer on the InP/ZnS core is provided.

### Experimental Examples 1-5

### Comparing Photo-Efficiency of Semiconductor Nanocrystal Formed with the Additional ZnS Shell Depending Upon Whether Including GaP Passivation Layer on InP/ZnS Core

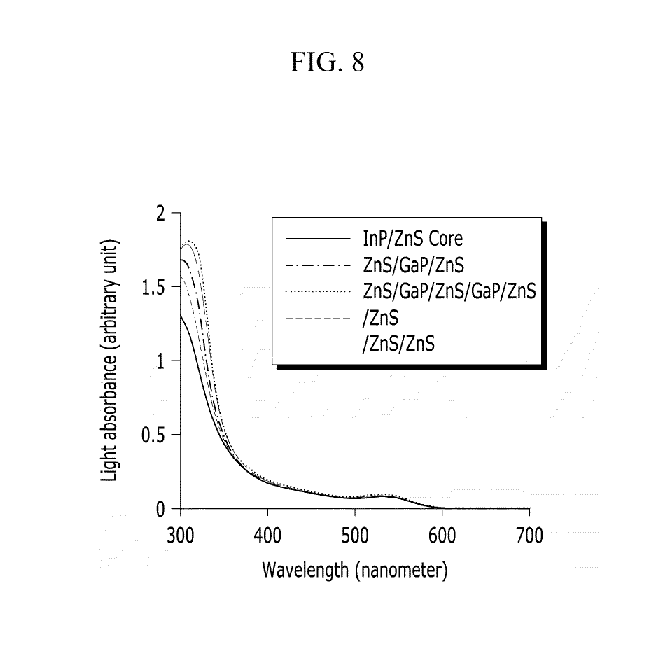

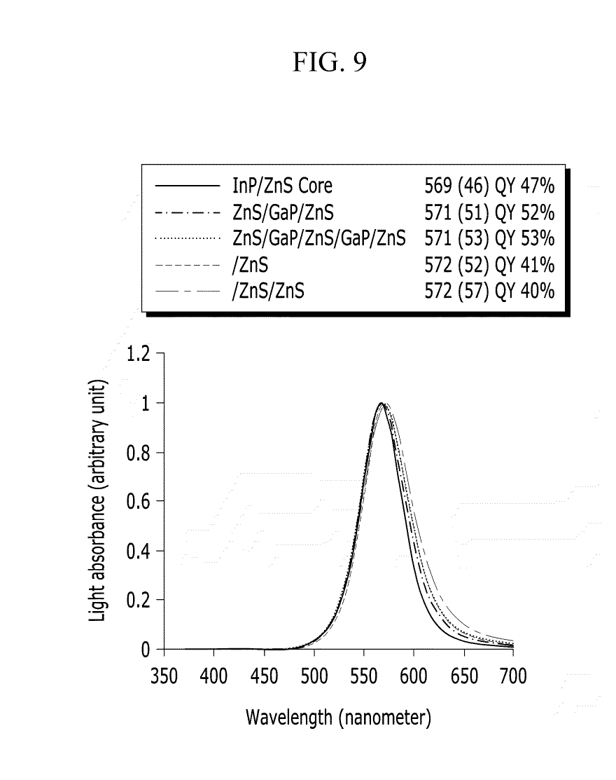

The light absorption spectrum, the light emitting spectrum, and the photo-efficiency are measured for the InP/ZnS nanocrystal core including no shell layer; the nanocrystal formed with a GaP and ZnS shell layer on the nanocrystal as in Example 11; the semiconductor nanocrystal formed again with a second GaP/ZnS shell layer on the surface of the nanocrystal having the GaP and ZnS shell layer; and the semiconductor nanocrystals applied with one or two processes of forming a ZnS shell layer on the InP/ZnS nanocrystal core without a GaP coating, and the results are shown in the graph (referring to FIGS. 8 and 9).

From FIGS. 8 and 9, it is understood that the semiconductor nanocrystal including the GaP shell layer between the core layer and ZnS shell layer provides high semiconductor nanocrystal production efficiency and higher photo-efficiency of the produced nanocrystal. It is indicated that GaP may be an excellent material for a passivation layer by lowering the lattice mismatch between the InP core and ZnS shell and providing a wider energy bandgap than the bandgap of the core.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A composition for preparing a nanocrystal, the composition comprising:
(i) a Group II and/or Group III precursor;
(ii) a Group VI and/or Group V precursor;
(iii) an acid anhydride or acyl halide; and
(iv) a solvent.

2. The composition of claim 1, wherein the acid anhydride comprises:
at least one fatty acid anhydride selected from oleic anhydride, linolenic anhydride, stearic anhydride, lauric anhydride, and palmitic anhydride,
at least one anhydride of phosphonic acid selected from hexyl phosphonic acid, n-octyl phosphonic acid, tetradecyl phosphonic acid, and octadecyl phosphonic acid, or
at least one cyclic anhydride selected from succinic anhydride and (2-dodecen-1-yl)succinic anhydride.

3. The composition of claim 1, wherein an amount of the acid anhydride or acyl halide in the composition is about 20 mol % to about 90 mol % based on the total of 100 mol % of (i) the Group II and/or Group III precursor, (ii) the Group VI and/or Group V precursor, and (iii) the acid anhydride or acyl halide.

4. The composition of claim 1, wherein the nanocrystal is a core of a semiconductor nanocrystal.

5. The composition of claim 1, wherein the nanocrystal is a semiconductor nanocrystal comprising a passivation shell layer formed from the Group II and the Group VI precursor and/or a passivation shell layer formed from the Group III precursor and the Group V precursor on a surface of a semiconductor nanocrystal core.

6. The composition of claim 1, wherein (i) the Group II and/or Group III precursor, (ii) the Group VI and/or Group V precursor, and (iii) the acid anhydride or acyl halide is each present as an individual compound.

7. The composition of claim 1, wherein (i) the Group II and/or Group III precursor and (ii) the Group VI and/or Group V precursor are each present in a form of a complex.

8. The composition of claim 1, wherein (i) the Group II and/or Group III precursor, (ii) the Group VI and/or Group V precursor, and (iii) the acid anhydride or acyl halide are present in a form of a complex.

9. The composition of claim 1, wherein the Group II and/or Group III precursor are present in a form of an alkyl metal precursor, a metal salt, or a metal oxide.

10. The composition of claim 1, wherein the Group VI or Group V precursor is a C1 to C36 alkyl thiol; S, Se, or Te dissolved in a C1 to C36 alkyl phosphine; S, Se, or Te; trimethylsilyl selenium, trimethylsilyl sulfur, or trimethylsilyl phosphine; tris-dimethylamido gallium; a C1 to C36 alkyl phosphine; or a C1 to C36 alkyl phosphite.

11. The composition of claim 10, wherein the acyl halide is an acetyl halide, a benzoyl halide, or an acyl halide comprising a C1 to C20 alkyl group.

12. A method of preparing a semiconductor nanocrystal, the method comprising:
adding (i) a Group II and/or Group III precursor, (ii) a Group VI and/or Group V precursor, and (iii) an acid anhydride or acyl halide to a solvent to form a mixture.

13. The method of claim 12, wherein the method further comprises reacting the mixture of (i) the Group II and/or Group III precursor, (ii) the Group VI and/or Group V precursor, (iii) the acid anhydride or acyl halide, and the solvent upon heating.

14. The method of claim 12, wherein the method comprises adding a previously prepared semiconductor nanocrystal to the mixture of (i) the Group II and/or Group III precursor, (ii) the Group VI and/or Group V precursor, and (iii) the acid anhydride or acyl halide, and the solvent.

15. The method of claim 14, wherein the semiconductor nanocrystal comprises a passivation layer formed from the Group II precursor and/or the Group III precursor, and the Group VI and/or Group V precursor on a surface of the previously prepared semiconductor nanocrystal.

16. The method of claim 12, wherein the method further comprises adding a second Group II and/or Group III precursor, and a second Group VI and/or Group V precursor to the solvent.

17. The method of claim 1, wherein the Group III precursor is a Ga precursor, and the Group V precursor is a P precursor.

18. The method of claim 12, wherein the Group III precursor is a Ga precursor, and the Group V precursor is a P precursor.

19. The method of claim 12, wherein the acyl halide is acetyl fluoride, acetyl chloride, acetyl bromide, acetyl iodide, benzoyl fluoride, benzoyl chloride, benzoyl bromide, benzoyl iodide, or acyl fluoride comprising a C1 to C20 alkyl group, acyl chloride comprising a C1 to C20 alkyl group, acyl bromide comprising a C1 to C20 alkyl group, or acyl iodide comprising a C1 to C20 alkyl group.

20. The composition of claim 1, wherein the solvent comprises a C6 to C22 alkane, a C6 to C22 alkene, a C6 to C22 alkyne; trioctylamine, trioctylphosphine, trioctylphosphine oxide, octyl ether, benzyl ether, or a combination thereof.
